(19) United States
(12) Patent Application Publication
(10) Pub. No.: US 2008/0235351 A1
(43) Pub. Date: Sep. 25, 2008

(54) Apparatus, Systems and Methods for Targeted Content Delivery

(75) Inventors: Jasminder Banga, San Francisco, CA (US); Nitin Shah, Cupertino, CA (US); Brijesh Patel, Gilroy, CA (US); Amul Patel, Pacifica, CA (US)

Correspondence Address: DLA PIPER US LLP, 2000 UNIVERSITY AVENUE, E. PALO ALTO, CA, 94303-2248, US

(73) Assignee: FEEVA TECHNOLOGY, INC., San Francisco, CA (US)

(21) Appl. No.: 12/065,499

(22) PCT Filed: Aug. 30, 2006
(86) PCT No.: PCT/US06/34086

§ 371 Date: May 22, 2008

Related U.S. Application Data
(60) Provisional application No. 60/712,911, filed on Aug. 30, 2005.

(51) Int. Cl. G06F 15/173; G06F 15/16

(52) U.S. Cl. 709/218; 709/224

(57) ABSTRACT

According to some embodiments of the present invention, a system, apparatus and method for targeted content delivery is presented. In some embodiments, the method comprises registering users logging-on to a computer network and gathering user-related information from users. Location-centric information for each user logged-on to the network is relayed to a server, and user-profile information for each user is retrieved from a database. User-profile and location-centric information for each user is processed to get targeting information for each user and the targeting information is sent to a content-provider wherein the content-provider uses the targeting information to select content to be displayed to each user. In some embodiments, user-profile and location-centric information may be gathered from wireless access points to which users log-on in order to access the Internet.

### BACKGROUND

1. Technical Field

The present invention relates generally to systems and methods for targeted content delivery, and more specifically to methodologies for the targeted delivery of commercial and advertising content.

2. Description of Related Art

The emergence of the World Wide Web (“the Web”) over the past decade has spawned a teeming online community of Internet users drawn by the rich interactive multimedia content available on the web, and by the ease of transacting business online. To a large extent, the proliferation of commercial activities on the Web (“E-commerce”) has been driven by exclusively online or virtual retailers and, more recently, by the online presence of traditional “brick and mortar” stores.

Typically, Internet users obtain information from content-rich sites on the web such as news related sites, or portals, which offer links to sites that offer the content users are seeking, or through search engines that scour the web to glean the information users seek. Web sites often place markers called “cookies” on users computers based on the content viewed. Cookies may then be read and updated to build a user profile.

Although cookies may be used to deliver targeted content, this approach has several drawbacks. First, a site can only use the cookies that it sets to target visitors to its site. This leads to a rather compartmentalized view of a user based on the site's limited past experience with the user. Next, the user must visit the site that set the cookie before it can be read to deliver any targeted content. Finally, with the rapid upsurge and continued growth in mobile computing, user-profile related information stored in a cookie might be irrelevant or hopelessly inaccurate. For example, geographic location information about a user may change quickly. Thus, displaying an advertisement for a store in New Orleans, La. may be a waste of server resources if the user is currently in Paris, France. On the other hand, the advertising may be extremely effective if the advertising was directed to Cajun or Creole restaurants in Paris, France. Making such content delivery decisions requires website-independent user-related information that is dynamically updateable and usable in real-time. Cookies are also subject to deletion. The solution described can supplement, replace and even improve current cookie use. Allowing the delivery of content customized to the individual device without any third party software or information stored directly on the device.

To compound the problems facing advertising content deliverers, Internet users are becoming increasingly unreceptive to traditional advertising techniques such as banners or pop-up windows. Thus, advertisers are resorting to more content-rich advertising, where advertising is done more suggestively through content-placement at strategic points in the presentation. Content-rich advertising is effective but demands greater data bandwidth thus leaving less time for content deliverers to process user-profile related information and make real-time targeting decisions. Moreover, with increasing concerns about privacy and data security a large number of users routinely delete cookies and other tracking information stored on their computers making such targeting decisions difficult, if not impossible. As a result, content servers have resorted to a fixed pool of content that is served up to website-users round robin with little or no effort directed at targeting.

Revenue streams for advertising content deliverers are based on click-through rates by users. In other words, the revenue stream often depends on the number of users responding to an advertisement rather than the raw number of advertisements served to users. Thus, on one hand the untargeted round robin delivery scheme limits the number and types of advertisements within a pool because each advertisement is served to a large number of users. On the other hand, advertisers lose revenue because untargeted advertising will generally result in lower click-through rates.

Wireless Access Points (“AP”) offer an approach to target a diverse group of mobile users. APs provide a gateway for mobile computing users to access the web and may also be able to provide location specific information to advertisers. However, such access points have hitherto been difficult and expensive to deploy. Moreover, current implementations do not offer the extensive data gathering and information processing capabilities required for the targeted delivery of content.

In general, traditional methods and systems for the delivery of content to users make broad website-specific static generalizations regarding user profile and behavior and thus are incapable of intelligent adaptive real-time delivery of targeted content. Moreover, even when data such as location-related data is available, current methods require complex correlations of disparate databases. Such correlations result in significant delay and degradation of performance so that end-users cannot get timely information pertinent to their location. Because of these limitations, content and service providers also face a barrier. If the performance is limited, and if the range of devices and locations is limited, service providers cannot ensure providing a uniform level of service to users. Thus, mass-market deployment with a priori knowledge that the service cannot serve many elements of the market is both infeasible and prohibitively expensive.

There is therefore a need for efficient, easy to deploy, adaptive learning methodologies and systems that build website-independent user-profile related information, and that are capable of updating, adaptively processing and delivering targeted content in real-time to an increasingly mobile computing community.

### SUMMARY

In accordance with the present invention, systems and methods for network operation, information gathering and processing, and targeted content delivery including approached involving business and advertising methodologies are presented.

According to some embodiments of the present invention, a system, apparatus and method for targeted content delivery is presented. In some embodiments, the method comprises registering users logging-on to a computer network and gathering user-related information from users. Location-centric information for each user logged-on to the network is relayed to a server, and user-profile information for each user is retrieved from a database. In some embodiments, if a user-profile is not present in the database, a new entry and profile-information may be created in the database. User-profile and location-centric information for each user is processed to get targeting information for each user and the targeting information is sent to a content-provider wherein the content-provider uses the targeting information to select content to be displayed to users. In some embodiments, user-profile and location-centric information may be gathered from wireless access points to which users log-on in order to access the Internet. In some embodiments, the wireless network may be publicly accessible.

Methods according to some embodiments of the invention also relate to the targeted delivery of commercial content and increasing the inventory of commercial content available for delivery by web site operators. In some embodiments, a large inventory of targetable content is stored on a server and targeting information pertaining to users is received and correlated with the targetable content. In some embodiments, targetable content is then selected for display on the user's browser based on the correlation between targeting information received for that user and the targetable content. In some embodiments, the targetable content selected for display on the user's browser may be modified prior to being displayed based on user-preferences or other criteria. In some embodiments, the targetable content selected for display on the user's browser may be modified based on parameters of the display device being used by the web-site user.

In some methods for targeted content delivery, the use of consumer related information gathered allows for an increase in the advertisement inventory available on an advertising server for targeted delivery to consumers. In some embodiments, such an increase in advertising inventory and content delivery may be accomplished with existing systems without associated increases in bandwidth requirements.

These and other embodiments are more fully described and their principles of operation explained in the following sections.

### BRIEF DESCRIPTION OF THE DRAWINGS

FIG. 1A shows a block diagram illustrating an exemplary system for targeted content delivery according to some embodiments of the present invention.

FIG. 1B shows a block diagram illustrating the architecture of an exemplary platform for targeted content delivery according to some embodiments of the present invention.

FIGS. 1C(i) and 1C(ii) show illustrations of a business method/advertising feedback models.

FIG. 1D shows a block diagram illustrating several exemplary AP server implementations according to some embodiments of the present invention.

FIG. 1E shows a diagram illustrating the integration of an exemplary XML gateway into the platform according to some embodiments of the present invention.

FIG. 2 shows a flow chart illustrating an exemplary process for implementing network operation and information processing, according to some embodiments of the present invention.

FIG. 3 shows a flow chart illustrating an exemplary process for implementing network operation and information processing according to some embodiments of the present invention.

FIG. 4 shows a flow chart illustrating an exemplary process for implementing network operation and information processing according to some embodiments of the present invention.

FIG. 5 shows a flow chart illustrating an exemplary process for implementing network operation and information processing according to some embodiments of the present invention.

FIG. 6 shows a flow diagram illustrating an exemplary process for implementing network operation and information processing according to some embodiments of the present invention.

FIG. 7 shows a flow diagram illustrating an exemplary process for implementing network operation and information processing according to some embodiments of the present invention.

FIG. 8 shows a flow chart illustrating an exemplary process for implementing network operation and information processing according to some embodiments of the present invention.

FIG. 9 shows a flow diagram illustrating an exemplary process for implementing network operation and information processing according to one or more embodiments of the present invention.

FIG. 10 shows a flow diagram illustrating an exemplary process for implementing network operation and information processing according to one or more embodiments of the present invention.

FIG. 11A shows a chart illustrating various business method/model considerations relating to online advertising implementations according to one or more embodiments of the present invention.

FIG. 11B shows a chart illustrating various business method/model considerations relating to online advertising implementations according to one or more embodiments of the present invention.

FIG. 11C shows a chart illustrating various business method/model considerations relating to online advertising implementations according to one or more embodiments of the present invention.

FIG. 11D shows a chart illustrating various business method/model considerations relating to online advertising implementations according to one or more embodiments of the present invention.

FIG. 11E shows a chart illustrating various business method/model considerations relating to online advertising implementations according to one or more embodiments of the present invention.

FIG. 12 illustrates traditional web-based advertising methodology.

FIG. 13 illustrates a targeted advertising methodology according to embodiments of the present invention.

FIG. 14 illustrates current advertising inventory at a site using traditional web-based advertising methodologies.

FIG. 15 illustrates how advertising inventory has increased at the site following adoption of methodology according to embodiments of the invention.

### DETAILED DESCRIPTION

In accordance with the present invention, systems and methods for network operation, information gathering and processing, and targeted content delivery are presented. In some embodiments, the targeted content may include commercial and advertising information. In this regard, the disclosure in each of the provisional applications listed below: U.S. 60/664,322 entitled, “Systems and Methods of Network Operation and Information Processing, Including Engaging Users of a Public Access Network,” filed Mar. 22, 2005; U.S. 60/680,330 entitled, “Systems and Methods of Network Operation and Information Processing, Including an Access Point,” filed May 11, 2005; U.S. 60/680,604 entitled, “Systems and Methods of Network Operation and Information Processing, Including Business and Advertising Methods,” filed May 12, 2005, is incorporated herein by reference, in its entirety.

According to some embodiments of the present invention a “system in a box” solution for wireless access point deployment is presented. In some embodiments the system in a box solution could work with an existing access point to provide additional services and methods according to embodiments of the invention. In some embodiments, the system providing access point services gathers information related to devices and users using AP services, including user and device identification information, and browsing history related information. The gathered information is combined with location specific information and the combined information relayed to a server for storage in a database. In some embodiments with targeted content delivery, the system identifies users or devices when they seek access to AP services, may update location specific information in the database, and download user and/or device profile information to a network proximate cache for easier access. In some methods for targeted content delivery, user and device profile related information may be relayed to sites visited by the user to aid in the selection of commercial content. In some embodiments, commercial content information destined for a user may be reformatted, changed, or enhanced based on the device type utilized by the user. In some embodiments, site-specific templates pertaining to web pages may be stored on a server or accessed from a proximate network cache, and the templates used to modify or substitute commercial content based on user and/or device profile information before delivery to the user. In some methods, commercial content of the messages may be continuously adjusted based on user-interaction or receptivity to the commercial or advertisement.

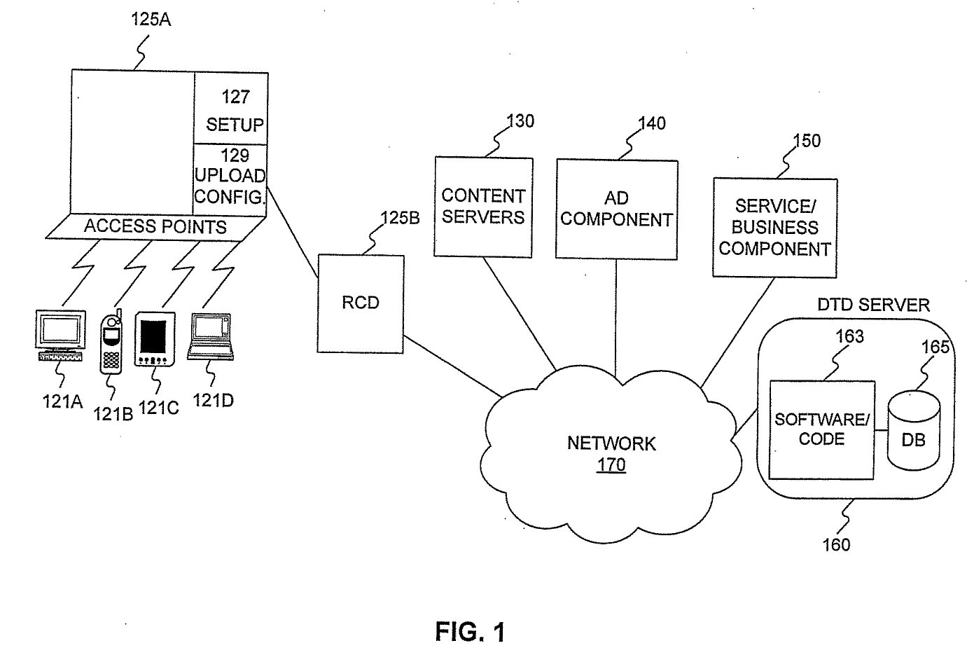

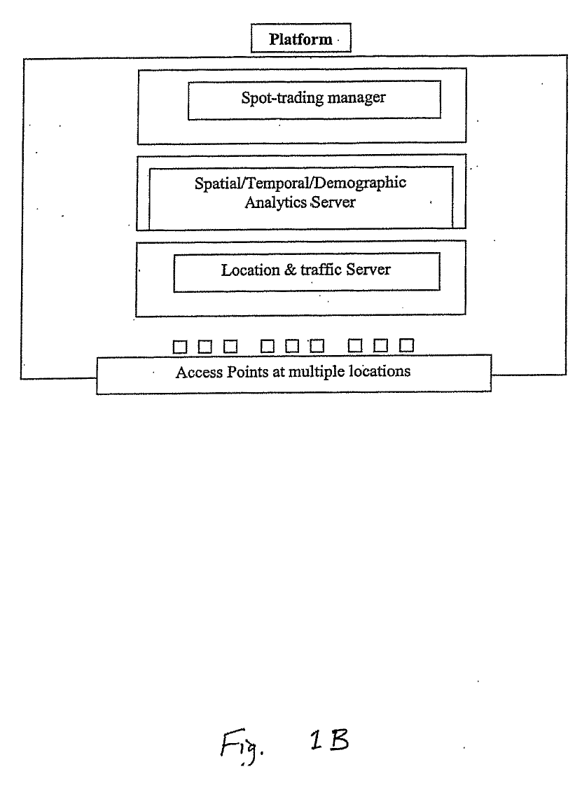

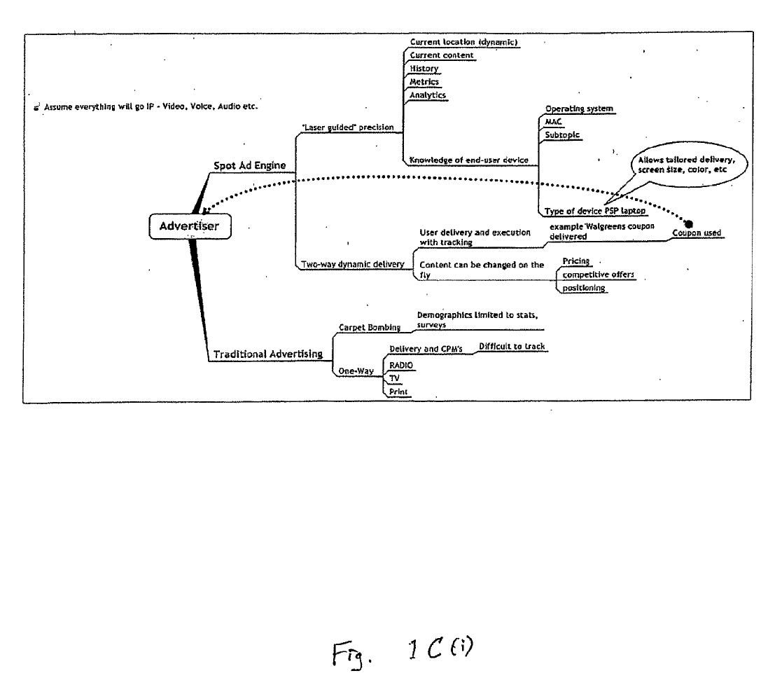

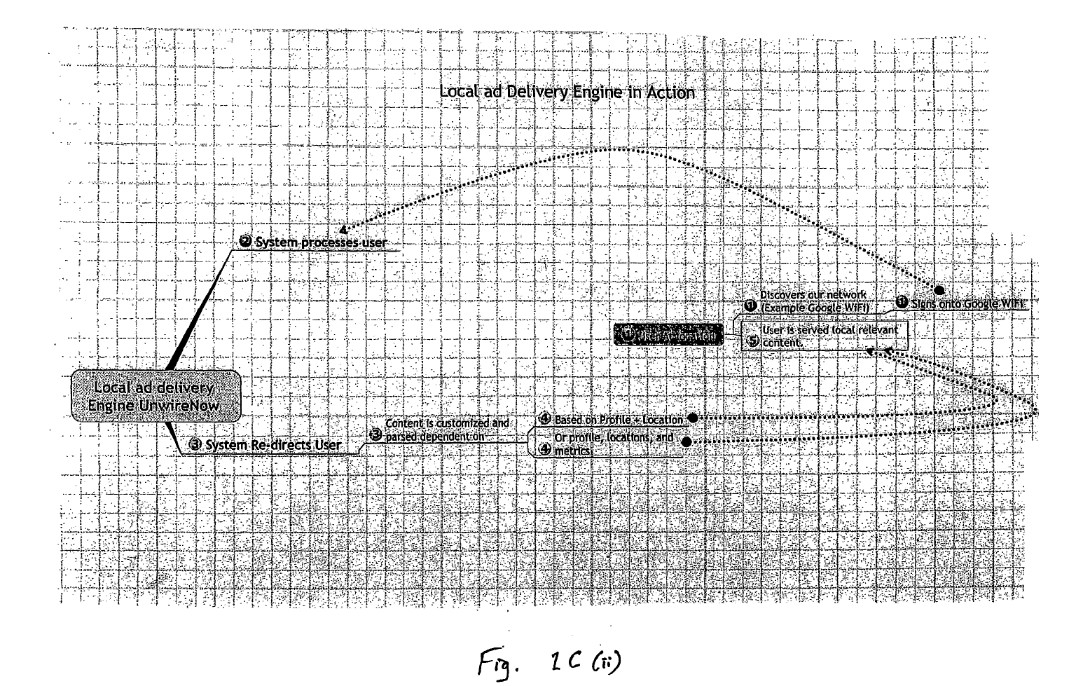

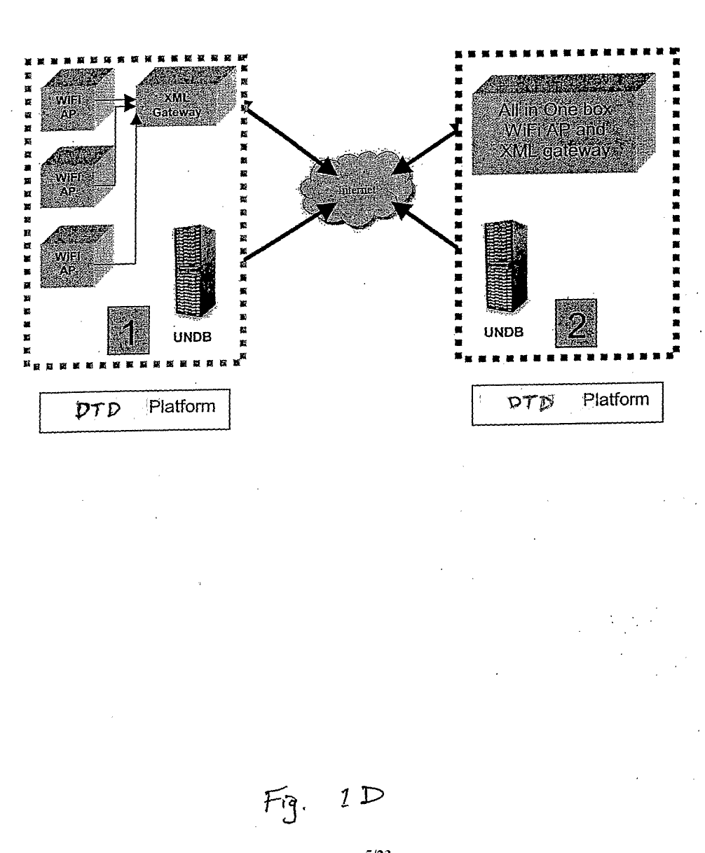

FIG. 1A depicts an exemplary system 100 consistent with one or more embodiments of the present invention. Components of system 100 can be implemented through any suitable combination of hardware, software, and/or firmware.

As shown in FIG. 1A, according to some embodiments of the present invention, system 100 can include the following exemplary system software and hardware. In some embodiments, the servers and related systems shown in FIG. 1A may be standard off-the-shelf components. For example, a Device and Targeting Database Server (“DTD Server”) 160 may include a database 165, which may use a Microsoft (“MS”) SQL Server, and/or other programs or code 163 to access and present information in the database. In some embodiments, systems may use languages such as SQL, XML, SOAP, ASP, and HTTP, etc. to perform tasks, although any suitable programming language or tool could also be used.

Information in database 165 is updated over network 170 using information gathered by access-related elements, e.g., Routing/Connectivity Devices 125A and/or 125B (“RCD” or “RCDs”), which may be distributed as shown in FIG. 1A or unitary, from clients 121 connected thereto. In some embodiments, RCDs 125 may request user and device profile information from the DTD Server 160, if it determines that a particular user or device has accessed the system on a prior occasion. In some embodiments, user or device profile information may be downloaded to a proximate network cache (not shown) for quicker access. In some embodiments, according to the present invention multiple mirrored DTD servers may be used and physically and geographically distributed over network 170. Network 170 could be a LAN, WAN or the Internet. In some embodiments, the AP server 120 may be a proprietary server offering a system in a box solution. In some embodiments, RCDs 125 could be used with existing access point systems such as remote wireless access point/servers from generic providers, for example, Proxim, Linksys, Dlink, Compex, Buffalo Technologies, Netgear, Terabeam, Nomadix, and Plug Inn Go, etc. In some embodiments, the targeted content delivery system may also be used or implemented with wired technology. Embodiments of the targeted content delivery system may also include signal amplifiers, external antennas, signal splitters, and other standard equipment as components.

In some embodiments, when an end-user browses web sites using a computing device, RCD 125 collects information regarding browsing habits and relays this information to DTD Server 160, where a database record for the user and/or device may be updated. In some embodiments, RCD may also download information from DTD Server 160 and modify and send some of this information to Content Server 130 and/or Ad Component 140. In some embodiments, user and/or device profile information received by Content Server 130 from RCD 125 may be used by Content Server 130 to determine which advertisements to retrieve from Ad Component 140. Content and advertising information are combined by Content Server 130 and sent to RCD 125, which sends this to client 121. In some embodiments, RCD 125 may modify the content or advertising received over the network 170 based on device characteristics. For example, if client 121 is a handheld device, the format of the content may be modified to better suit the screen and other characteristics of that handheld device.

The broader platform and location-centric functionality are now described in the context of the targeted content delivery system. In some embodiments, location-centric features may pertain to physical locations, such as any trafficked area including transportation centers, public parks and public outdoor areas, public indoor areas (such as libraries) and lobbies of hotels, malls, retail stores, eating places, rental centers, etc. According to embodiments of the invention, location-centric information is defined not only by a specific geographic location (e.g., latitude and longitude), but also by environment, such as areas of interest around the physical location. For example, tourist sites, eating places, hotels, shopping areas, entertainment areas, etc., may all be areas of interest regarding a location. In general, embodiments of the system may allow AP service providers using apparatus and/or methods of the present invention to configure portions of the RCD 125 with appropriate “areas of interest” data. Thus, embodiments of the present invention can include a catalog of all the potential action-related locations that the system provider may want in order to target users within a certain timeframe or distance from the location in question. In some embodiments, the present targeted content delivery system's “geo-targeting” of advertisements may also include information closely related to the demographics of the location such as climate, weather, ethnic mix of the community etc., and extend beyond the use of simple numerical information such as population density. Such location-centric awareness permits advertisements to be delivered and targeted to a community or a particular segment of the population.

The targeted content delivery system according to embodiments of the present invention is more effective than traditional advertising because the advertiser, coupon-deliverer, or information provider can adjust content in direct response to the measured response form the user. This is the first mechanism where the advertisements can be made genuinely interactive with the user and with the financial model (i.e. revenue generation by the user acting on the information and physically turning up to a location to perform a transaction.) Moreover, here, the fulfillment of a service is not delayed by the fact that the product needs to be shipped or delivered to the user; rather the user is directed to the nearby location that provides the product. In order to exploit the advantages of embodiments of the present invention, a software architecture or software platform, for realizing embodiments of the invention, may structured as set forth in FIG. 1B.

The software components shown in FIG. 1B may be deployed on DTD Server 160, or distributed across several physical computing devices which are connected by a network that permits data sharing. In some embodiments, for example, some or all of the functionality of the Location and Traffic Server may be distributed to RCDs, such as access-related RCD 125A. In some embodiments, the exemplary software platform shown in FIG. 1B may contain additional components (not shown) to perform other functions, as may be described elsewhere in this documents. Such functions could include computational or analytical engines and/or other types of servers. In some embodiments, such components may be a part of the components shown in FIG. 1B.

In some embodiments, the location and traffic server shown in FIG. 1B manages the channel configuration and location and installation profiles of the all the access points already in service. The location and traffic server can also transact with each new RCD, such as exemplary device RCD 125A, when it first is discovered on the network. In some embodiments, portions of the functionality of location and traffic server may be resident on RCD 125A. As each user enters a network at a particular location, the simplest function that the location and traffic server plays is to transfer that location information (i.e. a new user has entered the network at a particular place) so that this information can be delivered to a advertising or commercial content service provider (i.e. an applications interface which communicates with entities outside the targeted content delivery platform). The advertising or commercial content service provider then can perform whatever tasks it may want (e.g. display advertising, content etc. related to that particular location).

In some embodiments, a Spatial/Temporal/Demographic Analytics Server shown in FIG. 1B receives the location-centered data and information from the location and traffic server. This analytics server also receives information about the user from the location and traffic server. In some embodiments, user information may be altered to ensure privacy and anonymity, so as not to breach any privacy regulations that may be in effect, when this data is later shared with third parties.

In some embodiments, the Spatial/Temporal/Demographic Analytics Server may be part of DTD Server 160, where it may access database 165 as needed. At this point, the analytics server has a database not only of the locations of the RCDs and the activity at the access points of the clients, but also has residual demographic information, and current environmental information (such as weather, population densities), as well as information supplied by retailers or communities for special events, entertainment such as theater, plays, opera etc.

In some embodiments, the software platform may include a spot-trading manager component as shown in FIG. 1B. The spot-trading manager component presents an interface to those content providers (advertisers, event and conference holders etc) who would benefit from the fully interactive potential of the system. In some embodiments, the spot-trading manager component may be part of DTD Server 160.

In some embodiments, the spot-trading manager server has an external interface which can be driven either with an auction process or with pre-determined contractual processes, procedures, and rules to deliver specific types of content to users, based on some of the data supplied to the Analytics engine. For example, a pre-written contract with a soft drink manufacturer and a web site could trigger specific advertising content related to the soft drink to be delivered to users at any location in New York City where the local temperature in the City exceeds 90 degrees. By way of another example, a clothing retailer may have an agreement to advertise and supply coupons for rainwear when there is a weather forecast, which suggests rain in the window of the next 2-3 days.

In some embodiments, execution on such contracts could be implemented, in part, by using rule-based approaches coupled to a database system. FIGS. 1C(i) and 1C(ii) illustrate some approaches to advertising/business methodologies wherein, as detailed in the figures, the feedback and analytics of the platform act to enable an extremely efficient and directed advertising campaign. FIG. 1C(i) shows a flow diagram illustrating embodiments of methods consistent with the present invention while also contrasting the methods with traditional advertising methods. As shown in FIG. 1, the Spot Ad Engine uses information known or gathered regarding the current location, location related content, user location history, user browsing history, Machine Address Code (“MAC”) Identification (“ID”) address and information about the computing device coupled with other metrics to help the advertiser make decisions regarding content to be delivered. Moreover, in some embodiments, user interaction with a coupon or other interactive type advertising can be monitored to alter content based on user receptivity to certain offers (or the lack thereof). On the other hand, as shown in FIG. 1C(i) traditional advertising methodologies depend on carpet bombing an end-user based on broad demographic assumptions about the visitors to a site and do not provide mechanisms for real-time interactive modifications of advertising content based on user feedback.

FIG. 1C(ii) illustrates one mode of operation for the targeted content-delivery system according to embodiments of the system. As shown in FIG. 1C(ii), the DTD-associated network is associated with a publicly available Wi-Fi network. According to embodiments of the invention, when a user signs on to the Wi-Fi network, the event is detected by the DTD server or by other elements of the DTD-associated system. User-related information and local information are downloaded from the DTD Server, or from a network-cached image and this information is processed in order to deliver localized targeted content to the user using the spot-trading manager.

Embodiments of the system of FIG. 1A can also include a profile engine, which includes the ability to process MAC addresses (sometimes referred to as a MAC profile or MAC algorithm engine). In one or more embodiments, the profile engine is a system with an algorithm designed to profile the MAC address based on the number of times and which location it joins a network (e.g., in a Free Internet Zone), coupled with survey questions and/or responses. This information can be correlated in the processor and given weighted incremental numbers that then are placed in profile buckets. When a user requests Internet access, the MAC address profile ID can be associated with the location tag, and the request associated with this information can be matched up with an appropriate sponsor for that location.

Another advantage of this MAC profile engine, according to some embodiments, is that it can offer a unique relevant target for localized information/advertising or specific service to each user from the same network. A further advantage of implementing a MAC profile engine, according to one or embodiments of the present invention, is collecting network usage, which, in turn, allows the system to most efficiently deploy access points. An additional advantage in one or more embodiments allows for the determination of where it needs to move its access point for better utilization which helps reinforce the Internet access methodologies/economies set forth herein. Yet a further advantage is the ability to determine trend rates per zone, which is of value to advertisers in the local region. The MAC engine registers the MAC address in a database table along with the times of use, the AP location, and the MAC profile.

In some embodiments the DTD Server includes central authorization software that enables the system to inter-operate with hybrid public Internet access networks by receiving and tailoring content for the end user but without managing various remote hardware, such as a remote routers or access points. By managing the AP server or XML gateway (as opposed to the routers at remote location) this remotely managed, point of entry, networked, and targeted content-delivery system can co-exist with existing deployed networks with very few barriers. For example, even where an existing network has bandwidth limitations, such as for example, a business with a one megabyte/second data pipe up and down may still want to benefit by allowing a free internet zone to customers in its place of business. In such situations, the system may be configured so that the amount of network bandwidth not used by the business may be apportioned to users, for example, by limiting the public zone to 256 kbps up and 700 kbps down, and by limiting each user to no more than 128 kbps up and 500 kbps down. In some embodiments, the DTD Server site profile can be updated centrally to provide appropriate bandwidth when the request comes from a user, or to adjust the bandwidth based on time of day and consequent expected usage. In some embodiments, the bandwidth policy can be based on committed information rates, or respond to certain predetermined agreements based on business relationships (e.g. all users who are employees of a particular company will receive a committed information rate for their access to the network; or during times of civil disruption such as a natural emergency, the bandwidth can be tailored to ensure that emergency response users have preferred access, priority and bandwidth allocation, over that of normal commercial users.)

These Wi-Fi/DTD Server embodiments collect and provide pertinent information about a subscriber. This information can be, for example, information of value to commercial entities, and it can also be limited in its scope depending on the existing practices, legal, and/or other considerations.

In some embodiments, the spot-trading manager may be capable of supplying effective content-delivery efficiently to end users, and of generating revenues based on the effectiveness of the content-delivery, and from actions resulting from the delivery of content. In some embodiments, the spot-trading manager's functionality may be used for a dynamic real-time locale-related advertising trading system. Thus, the present invention provides an advertising technology and scale that is unprecedented, as it is targeted, personal, interactive, and location-dependent. Further implementation of the platforms, systems and methods of the present invention are set forth in Appendix B of the priority application (U.S. Provisional Patent Application No. 60/712,911), which is incorporated herein by reference in its entirety.

In some embodiments, specialized changes can be made to the AP both before shipment and on location. The changes to the access point solution-in-a-box or RCD 125 before shipment can include: (1) firmware installation, upload, updates, upgrades; (2) optionally, software code on top of the firmware; and (3) proprietary configurations, embodied in configuration files for above firmware and software. According to embodiments of the invention, proprietary configurations could include: (i) a unique identifier (serial number, or name, or other); and (ii) an IP address at the network management system to which the AP server will “report” after power-up.

In some embodiments, changes to the RCD 125 on location can include: (1) the automatic provisioning procedure on power-up to add the access point solution-in-a-box or RCD 125 to the network management system, including (i) requiring the RCD to contact to an IP address at the network management system for registration or “sign up,” (ii) transmission, by the AP server, of its unique identifier, and (iii) entry of the new AP server into a system/network/server database; and (2) changes and provisions relating to the location-specific setup of the box, including: (i) transmission of information and data from the DTD Server 160 to AP server 120, (ii) provision of service configuration, including new and/or updated service configuration, (iii) terms and condition pages for distribution to users, (iv) firewall and other security settings, updates, and configurations, (v) port specific setups, and (vi) authentication/authorization settings, among others, as set forth below.

Thus, embodiments of the invention may include a process and product by which the access point (AP) targeted delivery solution may be shipped to a location where there is available:
A commercial broadband connection typically Ethernet, but which could include DSL, Cable Modem, T-1, E-1 or fiber.
Local power to power the equipment
A suitable location (typically with considerable latitude regarding mounting logistics, but where either written or software directions would be provided to ensure that the antenna is properly located).

Among other advantages, some embodiments described herein also allow subscribers to: (1) lower the complexity of deployment of adding a location to within DTD-associated network, (2) increase ease-of-installation so that non-technical persons can install the access point, (3) speed up the time to bring a location (access point) online, and (4) increase desirability and/or acceptance vis-à-vis the decision makers (vendors, such as retailers, cafes, etc.). Thus, embodiments of the present invention allow the location owner (such as commercial retail enterprise, e.g. clothes store, restaurant, hardware store, etc.) to receive the AP solution via expedited shipment, and have the network up and running within minutes. The plug-and-play set up allows a network provider to distribute AP targeted delivery solution boxes at a rate, for example, of hundreds per day, in contrast to having to train and send out personnel to such locations, which would incur a cost of many hours per access point location. This model also scales to reach locations anywhere in the world, since the AP Servers 120 can be shipped to any location in the world, with the appropriate infrastructure described above.

According to embodiments of the present invention the AP server may be pre-configured via software with the location and key identification data before shipping to the location owner. Such pre-configuration allows the box to be instantly discovered by the system as soon as it is plugged into any broadband Internet connection. At this point, the box may be administered over the Internet. In addition, firmware and software upgrades may also be uploaded to the box. Examples of the information that can be loaded are: location, unique identification, channel and power configurations, and other information described in more detail below. In some embodiments, the loaded information can be subsequently used in a larger platform context. In some embodiments the MAC ID of devices using AP server 120 provides the raw material for measuring usage behavior on AP servers on the network. Since traffic can be remotely monitored, if the load on the network is excessive at a location, an additional AP server can be shipped to that location, so that both virtual and physical aspects of the network can be managed.

Some exemplary embodiments of deployment approaches and business methods follow. First, in some embodiments, public access can be made available adjacent to a business such as a retail location. In some embodiments of a method for targeted content delivery, a business may install one or more of the boxes on their premises to support both the internal operations of the business (e.g. laptops for the stocking staff in the building) and to provide internet access to customers, or others with mobile devices, wherein the public access network would be used for targeted content delivery. Second, in some embodiments, where there is no physical access to a business by an advertiser or content provider (e.g. the business is in a difficult to reach location), the platform/DTD engine set forth herein in conjunction with the present system can manage the AP server network and operations remotely. In some methods for deployment, a business relationship may be created with an existing public Wi-Fi network provider in a city where, in exchange for the provision of Wi-Fi services, targeted advertising or other commercial content is directed to end users.

The access point targeted content delivery solution can be deployed into the present systems and methods in a wide variety of ways. In some embodiments, the AP Server 120 is connected with the DTD Server 160; however, the implementation of other elements of the system can vary. FIG. 1D illustrates two possible system embodiments by which an AP may be integrated into the DTD-associated platform, a stand-alone implementation (Scenario “1,” as labeled in the figure), and as part of a system having the solution-in-a-box (Scenario “2”).

According to some embodiments, Scenario 1 can be a multi AP or “Bolt-on” solution for an existing network. According to embodiments in Scenario 1, an existing network, for example, could be transformed to a location-enabled system of the present invention through the insertion of an XML gateway at the broadband origin. FIG. 1E illustrates how an XML gateway may be integrated into the DTD-associated platform. In some embodiments, the XML gateway may be upgraded with the appropriate software or firmware, in order to be integrated in to the platform. In some embodiments, a pre-configured gateway could be supplied to perform the requisite location-centric DTD network transformation. Following the integration of the XML gateway, multiple “dumb,” generic inexpensive AP's could be deployed. In some embodiments, a properly configured XML gateway may perform some of the same information routing and processing functions as AP server 120. Scenario 2 can be any stand-alone installation where only one box is required, such as in businesses (cafes, retail establishments, restaurants, etc.). Exemplary products, tools or languages that may used to deploy the system include: (i) standard off the shelf server class computers, MS IIS web servers, databases including a MS SQL Servers, using SQL, and any of a combination of XML, SOAP, ASP, or HTTP languages; (ii) network operations, monitoring and scheduling equipment; (iii) remote location equipment; (iv) wireless hardware, such as may be provided by Proxim, Linksys Dlink, Compex, Buffalo Technologies, Netgear, Tearabeam, Nomadix, and Plug Inn Go; (v) signal amplifiers; (vi) external antennas; and (vii) one or more signal splitters. The components set forth above are only exemplary and equivalents may easily be substituted to achieve substantially the same functionality. Systems and methods of the present invention can be implemented on a variety of networks, both wireless networks such as Wi-Fi and via wired technology, as well as via any other known or emerging network technologies.

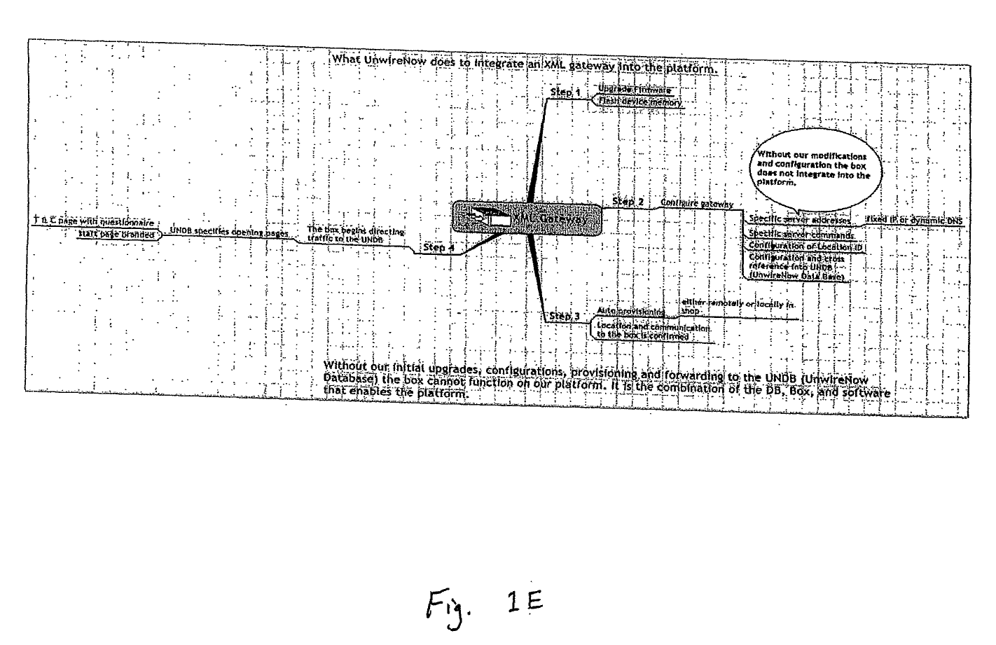

Furthermore, the above-described systems may also include various system reporting features and functionality. For example, identifier information such as MAC and UID may be used to track a user as they travel from location to location, and an identifier algorithm engine may be used to process and provide other identifier-related information. According to these embodiments, the identifier algorithm engine can register the identifier in a database, including the time(s) of use, the AP (access point) location, and the user profile. Specific illustrations of this functionality are set forth in connection with FIGS. 2-10, below.

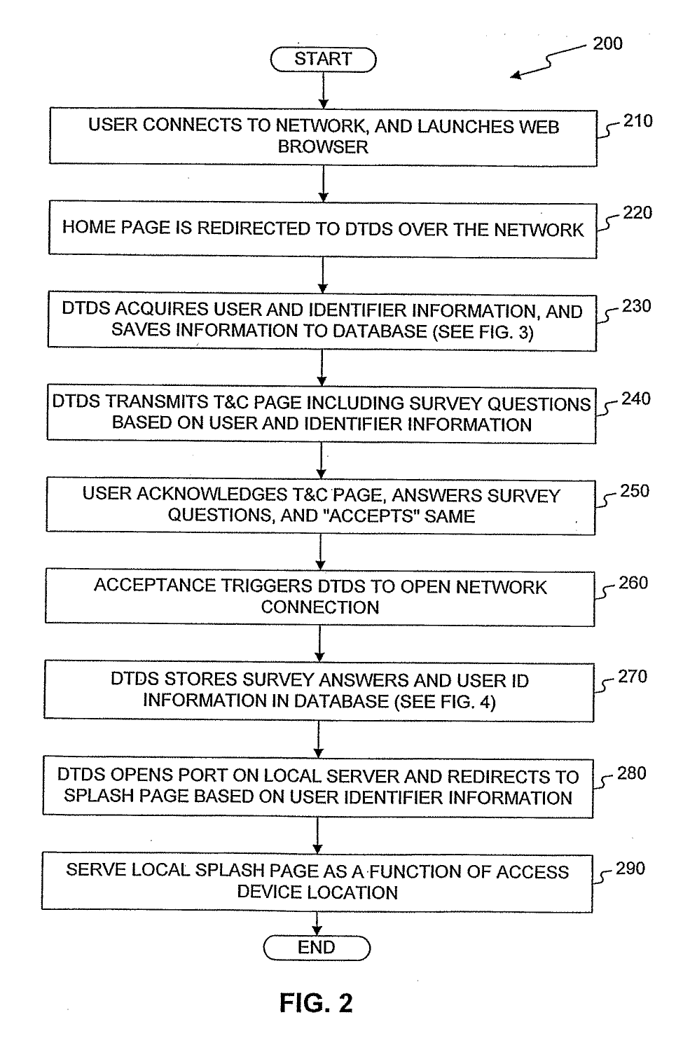

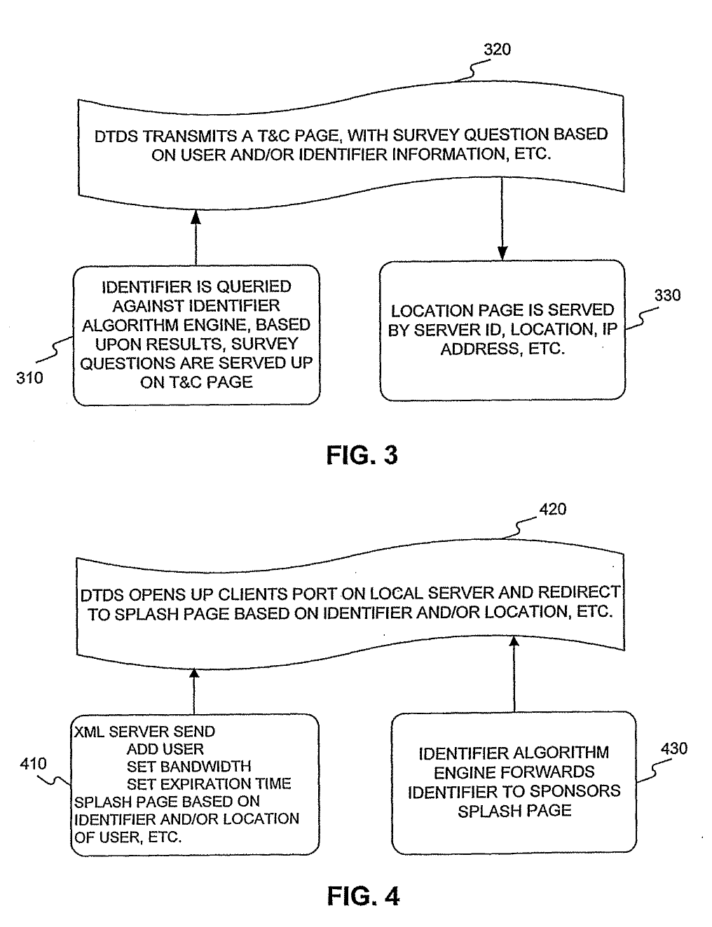

FIG. 2 depicts an exemplary flowchart with steps 200 consistent with one or more embodiments of the present invention. Referring to FIG. 2, a method of collecting and processing information consistent with certain aspects related to the present invention is illustrated. As shown in FIG. 2, an end-user first connects to a public network and launches a web browser (step 210). The browser is not allowed to access the default home page of the computing device, but rather is redirected to the DTD Server 160 over the network (step 220). Beginning with this very first handshake/data exchange whether through hypertext markup, radius accounting records, or back-channel communication, the DTD Server 160 acquires user profile and user identifier information, and begins saving this information to a database, this information can be new or simply building upon existing an existing profile (step 230). The profile protects user anonymity by using the UID as a proxy for the individual The information stored in the database may be, inter alia, time/date information, initial home and/or default page information, location information such as that derived from the server or access point IP address or ID, specific identifier information for the user (e.g., MAC address, etc.), additional information can be provided by third parties who wish exchange existing user/device information and/or store this third party information indexed by the UID for future transactional reference, as well as any other information acquired by the DTD Server 160 at this time. As a result of survey and profile engine processing (as detailed in connection with FIG. 3, below, and elsewhere), survey questions specific to each user are generated based upon the acquired information. DTD Server 160 then transmits first data such as a terms and conditions (T&C) page with these survey questions to the user (step 240). The user may then answer the survey questions and acknowledge the terms and conditions, for example, by selecting an “accept” button (step 250). In response to receipt of this acceptance, the DTD Server 160 can open or instruct the network equipment to open a network connection for the user (step 260). The DTD Server 160 also then stores the survey answers as well as any new or related user identifier information in a database (step 270). Additional processing related to this new (e.g., survey) information is performed by the DTD Server 160, as set forth in connection with FIG. 4. As a function of this additional processing, the DTD Server 160 opens up (or instructs network hardware to open) a client port on the local server and redirects the user to a splash page (also known as landing page) determined as a function of user identifier information with components customized for that individual (step 280). Suitable splash pages may be retrieved and stored in network cache. Finally, a local splash page, determined as a function of the access device location, is sent to the user's browser (step 290). Furthermore, all of the content transmitted to the user (e.g., first data, splash pages, etc.) may be formatted and/or indexed to the specific type of access device utilized by the user, as determined by the DTD Server 160. The cumulative profile generated by DTD can be accessed for future use during that session or sessions that follow.

FIG. 3 shows an exemplary technique regarding how information including survey questions may be generated, transmitted, and processed, according to one or more embodiments of the invention. First, the identifier is queried against an identifier algorithm engine 310 to determine if a profile exists for that user and, if so, which survey questions the user has already answered. Based on location, stored user profile information, and user responses, the DTD Server may decide to serve additional, unanswered survey questions. As a function of these determinations, any outstanding survey questions are associated with the terms and conditions (T&C) page. The DTDS 160 then transmits the T&C page with the survey questions 320. A location page may also be served as a function of server ID, location, IP address, etc. 330. In some embodiments, the information received typically enables the Profile Engine to serve up targeted advertisements (e.g., banner ads, rich media, video, audio, and other content keyed to user information such as location, user profile information, etc.), sponsor logos, and pages such as first pages, splash pages, etc.

FIG. 4 shows another exemplary technique regarding how information may be collected and processed when an XML gateway or Radius based implementation is used, according to one or more embodiments of the invention. As shown in FIG. 4, an XML Serving component of the DTD server may forward information such as identifier information (e.g., the MAC address of the access device), the bandwidth allowed to the user, and a session expiration time to the DTD Server 410. The DTD Server then opens up a port on the local server and redirects the browser to a splash page based on identifier and location information 420. The DTD Server may also retrieve user identifier information and downloads a splash page and local advertising information based on the associated user profile 430. DTD Server 160 may also access port numbers of the XML component to implement separate channels for acquiring or providing data to/from end users, advertisers, and content providers via this “back-door” technique. Radius server component could also accomplish similar data acquisition or provision based on Radius records that exist in a Radius-based environment, such as log-in files and history. However, in some embodiments of the present invention, intra-cell blocking to prevent client-to-client snooping is accomplished using without-radius technology.

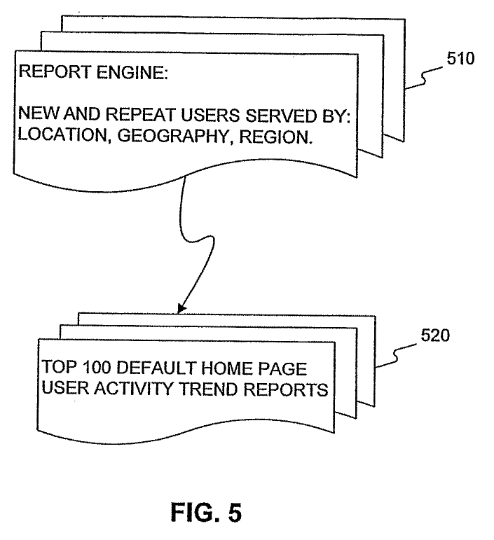

FIG. 5 illustrates other data gathering and reporting functions performed by one or more embodiments of the present invention. In some embodiments, aggregate information may be collected by a report engine, such as the number of new and repeat users at a given location 510. The report engine may parse these new and repeat user statistics according to location, geography, region, and other characteristics of user service. In some embodiments, a list of user-activity trend reports may be generated such as, for example, the top 100 default home pages used by users 520. Such trend information could be used to target potential web sites or advertisers to generated revenue for the DTD-associated network and targeted content delivery service. A simple profile can be created without knowing any personal information of an end user, but enough information may complied by eventually to offer relevant content based on the current location and time of day the user has accessed the network. In some embodiments, Pool IDs (PIDs) are created and a user profile may be associated with multiple Pools. A Pool is a high-level survey-based grouping that may be inferred based on survey results. Sub Pool IDs may also be used to provide a hierarchical relationships for sub-groups within these Pools. Other Pool-related data that may gathered and/or stored include, a Historical Profile Pool ID, which may include the evolution history of an identifier profile (e.g., a MAC profile), a Historical Location ID & Usage Counter, Historical Survey ID & Response, Survey Results Per Location, and all other combinations of Pool-related data with any user or profile related data maintained by any of the processing components.

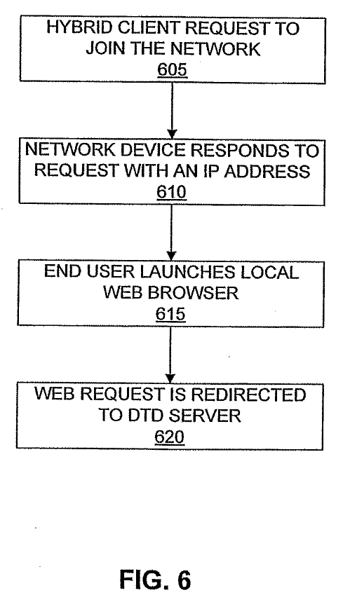

FIGS. 6-10 are flow diagrams illustrating some functionality of one or more embodiments of the present invention. Each step of embodiments of the algorithms shown in FIGS. 6-10 is demarked with a numerical identifier, 605 through 1010. The description of each step, in association with its numerical identifier, is set forth below.

In step 605, as shown in FIG. 6, a user connects to a hybrid network via any known mechanism, such as by a Wireless or an Ethernet connection. The access device (for example a PC, PDA, or Wi-Fi Phone) requests an IP address from a Routing/Connectivity or network device such as a local Dynamic Host Configuration Protocol (“DHCP”) server.

In step 610, the RCD or network device assigns an IP address to the access device. An access device identifier, such as the MAC address, is then registered in the RCD or network device and is placed in a pending status. When this identifier (i.e., MAC address, in the present example) is first seen on the network or a user registers to the system, the DTD Server instantly creates a profile ID and database record based upon this identifier information.

In step 615, the end user now launches a local web browser which makes its initial request to go to the user default home page.

In step 620, the RCD or network device intercepts the request and redirects the request to the DTD Server on the network, while also transmitting the identifier (e.g., here, MAC address), local IP address, and original home page URL, along with the network device IP address and other specific identifier information.

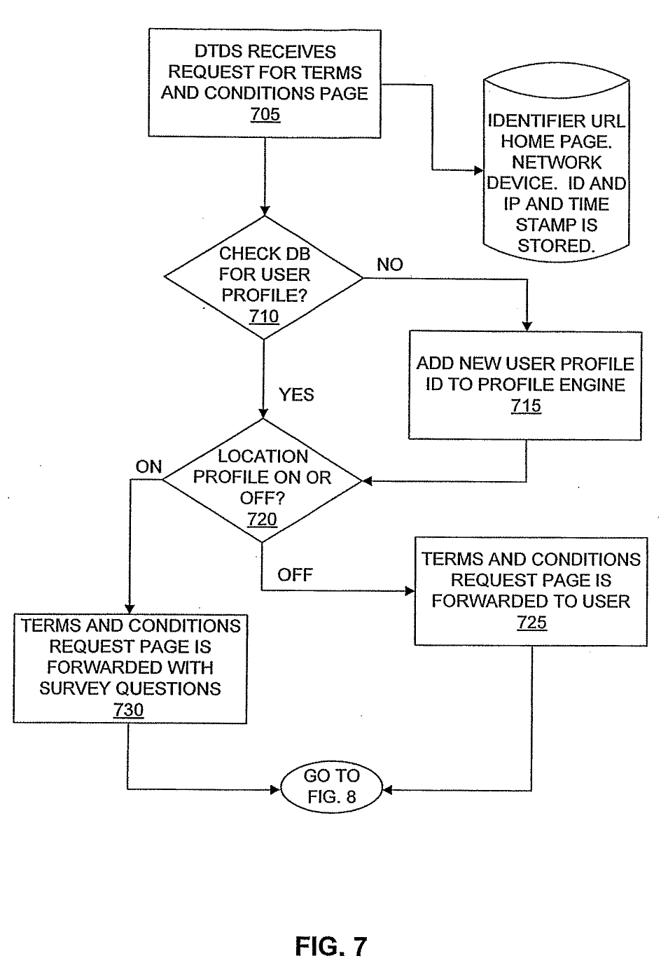

In step 705 as shown in FIG. 7, the DTD Server 160 receives a request for the local Terms & Condition (T&C) Page from the end user. During these initial exchanges, the following exemplary information may be acquired by the DTD Server and recorded in the Profile Engine: identifier information such as end user MAC Address, Local IP Address, Default Home Page URL, RCD and/or Network Device ID, Network IP Address (e.g., for RCD, Network Device, etc.), Location ID, Local Language on Computer, Operating System/Device Specific Information, Nest Requested Home Page, Survey Results, Date and Time Information, as well as other information derived from the access device, the user's behavior, or information concerning the user generated at or by the RCD.

In step 710, the DTD Server checks against the DB to see if the identifier acquired has an existing profile (profile ID) associated with it. In step 715, if there is no profile ID, then the identifier is added to the profile Engine and assigned a Profile ID.

In step 720, the location ID is checked against the location profile database to see if the profile tag is set to on or off. The profile tag is set to “off” if the identified user has an existing profile and answers to all of the survey questions are on file. If the profile engine is in need of the answers to outstanding survey questions, the profile tag is set to “on.”

In step 725, if the profile tag is set to off, then a Local T & C page is forwarded to the requesting end user's browser.

In step 730, if the profile tag is set to on, the location T & C Page is matched up with the user profile ID as well as the required survey question(s), which are forwarded to the end user browser by instruction from the DTD Server. The end user would never see the same survey question asked across any location on the network, since DTD Server tracks the identifier throughout the network.

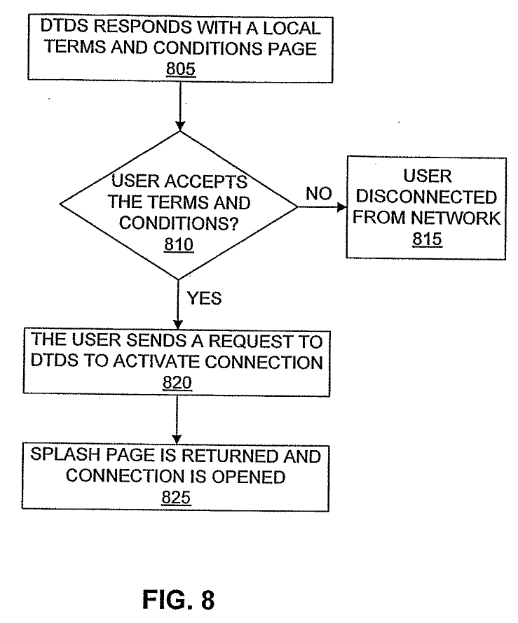

In step 805, as shown in FIG. 8, first data such as a welcome page with Terms & Conditions (T & C) is transmitted to the end user. This return page is already formatted to the device type, screen size, and format, which is/are specifically tuned to the device's capabilities.

In step 810, the end user is asked to accept or decline the T & C page condition. If a survey question is also provided here, the user has to answer the question in order to move forward.

In step 815, if the user clicks on the disagree button (regarding the T&C's), the user browser is redirected to a courtesy page requesting him or her to disconnect from the network. Alternately, a processing component may respond to a disagree selection by providing a less then full-service web experience. For example, a DTD Server may restrict the user's time or bandwidth on the network, or offer reduced guarantees of priority, traffic, and/or other performance characteristics as compared to those provided via acceptance of the terms and conditions. In some cases, these restrictions may be implemented by permitting basic web-browsing while blocking Virtual Private Networks, thus preventing a user, such as a corporate user, from accessing e-mail or using other important features associated with such networks. Restrictions may also be implemented by introducing jitter and/or delay to the extent that VoIP performance and real-time streaming of video services are not feasible or satisfactory, though browsing the web is still possible.

In step 820, if the user clicks on the Accept button, another request is sent to the DTD Server to activate a user's pending status to active status so they can now use the Internet freely. This is the unrestricted mode of using the access network, which allows the user to utilize all of the features and functionality of the Internet. However, access can still also be moderated by a pre-determined and/or real-time access control system. Such moderation or control may enable determination of the actual bandwidth and other performance characteristics contemplated. For instance, if certain identifiers have been pre-programmed within the network to restrict VPN access, then any policies of specific user access can be implemented at this stage. Next, in step 825, a splash page is transmitted to the user and a connection is opened.

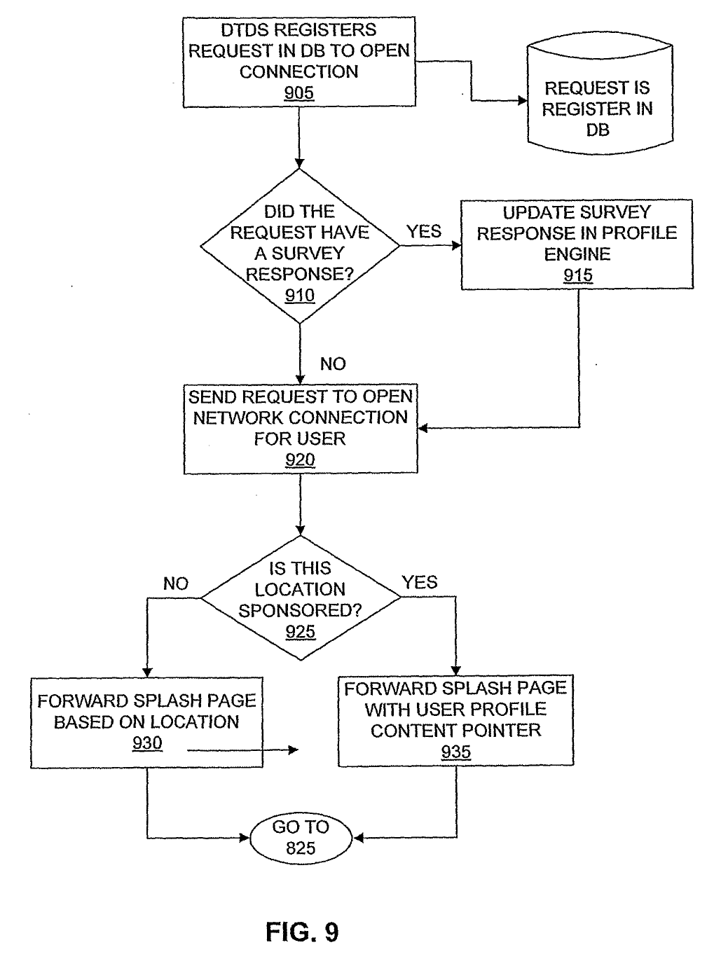

In step 905, as shown in FIG. 9, DTD Server registers the request and time of the request in an associated database. In step 910, if the request includes responses to survey answers, then they are forwarded to the Profile Engine. In step 915, survey answers are updated against data already stored for that user in the Profile Engine.

In step 920, the DTD Server now transmits some commands to the network device to activate the pending status, set the upload and download bandwidth speed per the identifier, and set an expiration time of when the user's session will expire for that network.

In step 925, the user's Location ID is checked to see if it has a sponsor associated with that location. In step 930, if there is no sponsor a generic local splash page will be sent to the requesting user. In step 935, if a sponsor is associated with that location ID based on the location profile database, a splash page with relevant local information, and a targeted advertisement based on the user's profile ID will be sent to the user.

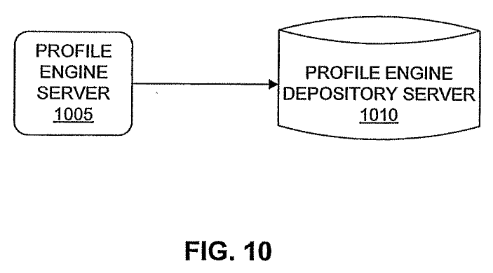

In step 1005, as shown in FIG. 10, the profile engine server performs the Profile Engine algorithms on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server, step 1010.

In some embodiments, an Advertisement Assignment Tag (AAT) may be used. The MT is an ID number assigned directly to a sponsors' web media campaign. This tag than can be run through our analytic queries to correlate interactions between MAC ID's and AAT ID's. A higher the AAT tag count associated with a MAC ID, implies that a more detailed profile is available with respect to the MAC ID. In some embodiments, an MT Engine may serve as the link that ties the DTD Server to third Party systems.

In some embodiments, a separate profile ID may be associated with each MAC ID. This ensures that the privacy of any single user cannot be compromised by any subsequent processing or sharing of the data because only profile ID information may be disclosed (MAC ID information need not be disclosed). In some embodiments, profile groups may be created. For example, all people who are within three blocks of Times Square and that have logged onto the network in the past hour, or all users who are currently logged on within a ten minute drive of a shopping mall in New Jersey, or all users who have responded to a simple survey to indicate their preferences, such as a color preference of blue over red. Profile groups allow the dynamic creation of loose relationships based on profiles and building upon previously gathered data or survey responses.

Regarding, in particular, the wireless implementation addressed above, the present invention provides particular advantages pertaining to direct access, location, traffic and network operations. With respect to direct access, the present invention provides direct connection to the customer and eliminates third party involvement in the delivery of content, as well as allowing for the licensee/subscriber/vendor to be the starting point of each and every communication (e.g., page, flash page, search, etc.) with the customer. With respect to location, the present invention provides the exact location of the customer, providing significantly greater value to related advertising and information. In other words, the more granular the information is about the customer, the more valuable it is to the advertisers (e.g., for directed advertising and other communications). Alternately, a more generalized location may be provided for the customer, such as region, zip code, etc., to protect user anonymity. With respect to traffic considerations, the cost methodologies addressed herein provide for greater accessibility, as costs present a significant competitive barrier. Specifically, embodiments of the present inventive methodology can provide free access by users, rather than requiring some sort of direct revenue from the end-user (although there can be fees associated with each subscription). Thus, regarding the maximization of traffic, these embodiments are particularly advantageous for networks that are: (1) carrier class, (2) easy to log onto, and (3) ubiquitous. Finally, with respect to network operations, the present methodology provides relatively low equipment costs with respect to prior network access of this nature, as well as the capability of avoiding the expenses of otherwise implementing/managing a network of this quality.

The technology set forth herein has particular applicability to the operation of WiFi networks, and especially companies closely associated with WiFi technology. The systems and methods of the present invention provide numerous advantages in the areas of network management and operation, data collection and aggregation, real-time provision of user demographics, location and other information, and reporting of WiFi network usage (summaries, aggregates, even real-time). For example, the WiFi embodiments have specific applicability to service providers, portals, and internet ad intermediaries.

For example, these WiFi embodiments provide unique advantages to service providers like VoIP (voice over IP) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). These WiFi embodiments also provide significant advantages to portals, such as real-time user demographics and location that allow for immediate, directed advertising. These WiFi embodiments also provide significant advantages to internet ad intermediaries, such as information management applicable to all of the many layers of service providers involved in having an ad (e.g., banner) displayed on a web page.

In another exemplary implementation, the present invention may help prevent click-fraud, or other activity of interest performed by users of the network. Here, the DTD server 160 has information about identifiers (such as MAC addresses) of every device on the network. This information can be associated with the cumulative number of clicks (on advertisements, marketing media etc), which can then be used to trigger a further audit if there is an anomalous number of clicks. This may allow an operator of the network, for example, to provide information about such anomalous behavior. This can be important, as the total number of clicks can be also traced to the number of clicks on a particular website and/or a particular advertiser's advertisements or content. As a result, the invention can be used as both an alerting mechanism and then a tracing mechanism to monitor and prevent click-fraud. In addition, if it is required, access to the network can be blocked for the offending device based on its identifier, so the user cannot access the network and continue with fraudulent or non-compliant practices.

In a further exemplary implementation, the present invention may also provide benefit in the areas of security and access control. Again, since user identifiers (such as MAC address) are known in the network, they can be mapped into dynamic databases which are used as a secondary mechanism of physical machine verification for access to networks, websites, and/or specific classes of digital content on a network or networks. Since the DTD Server has a database of all devices, it can interface with a large number of third-party databases. For example, it can interface with databases of allowed users who have high priority for access to the network in case of an emergency response situation, such as one directed, for example, to the whole network or just to a specific geographic location. Therefore, multiple classes of access, rules, syntax, and associations of such databases are done inside the DTD Server, enabling the network to develop intelligent rules for access to services and content based on unique combinations of these databases, and apply them to the identifier of the device.

In yet another exemplary implementation, the present invention may also provide benefit in the area of rule-based blocking of content. Specifically, the DTD Server may be employed to ensure that “no” content is delivered when none is desired. This functionality may be applicable, for example, when a network TV broadcast is scheduled for particular show times in certain regions in the world, or when movies and other digital content, such as music, are released in a carefully controlled fashion in a network. By having rules associated with content of this type, the DTD Server can determine if the user has the rights to receive and play the appropriate content. Such rights not being based solely on traditional DRM techniques, but rather on the time, location, and other parameters that the content provider can specify. For example, if an online program is released in Australia, with a release time scheduled hours later in New York, then the content provider can tag the content such that it cannot be downloaded and/or played until the appropriate release time determined by the content creator/distributor. Utilization of specific user identifiers ensures a layer of digital rights management enforceable via the network by association of the identifier and the DTD Server, by virtue of database interfaces, with the content rights and rules to be enforced by the content distributor.

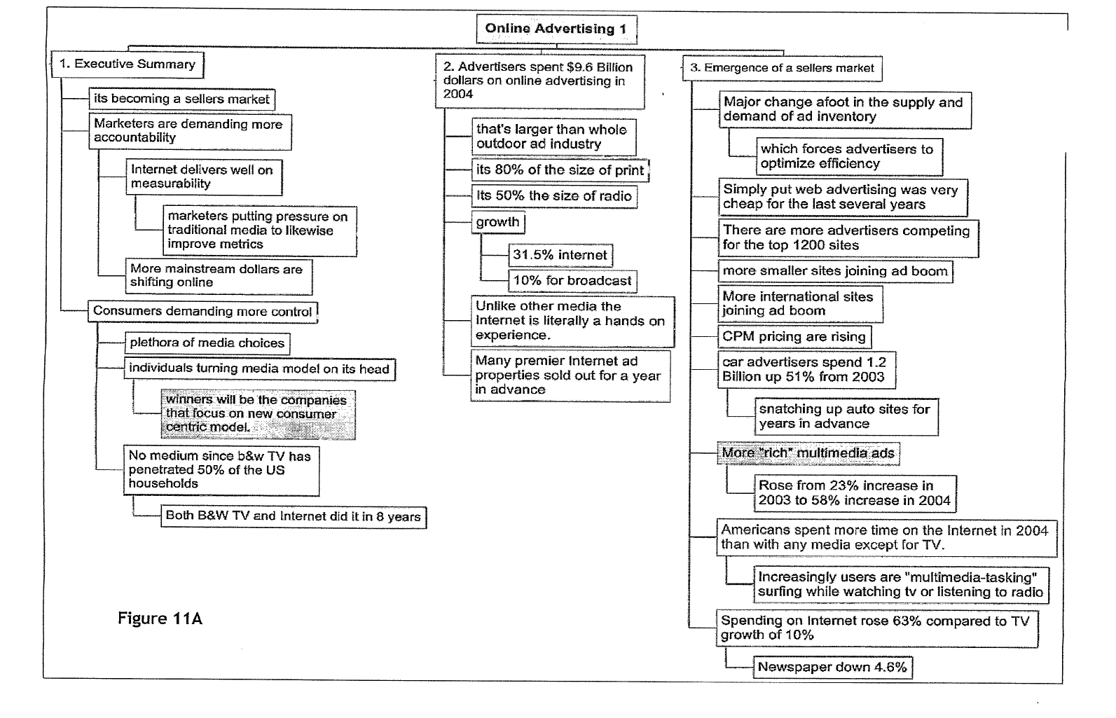

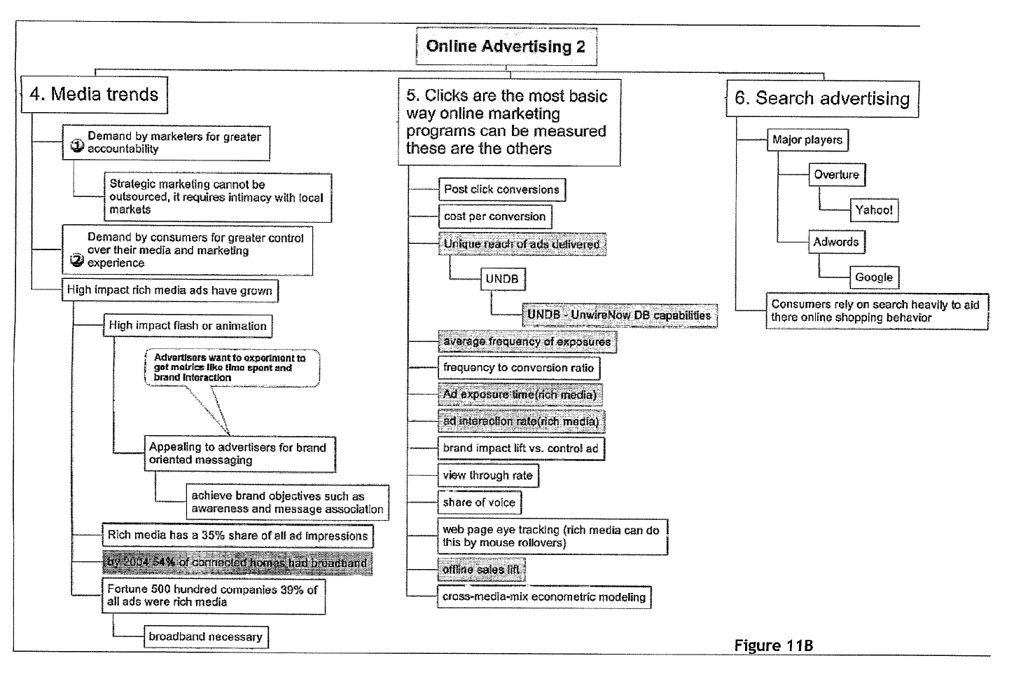

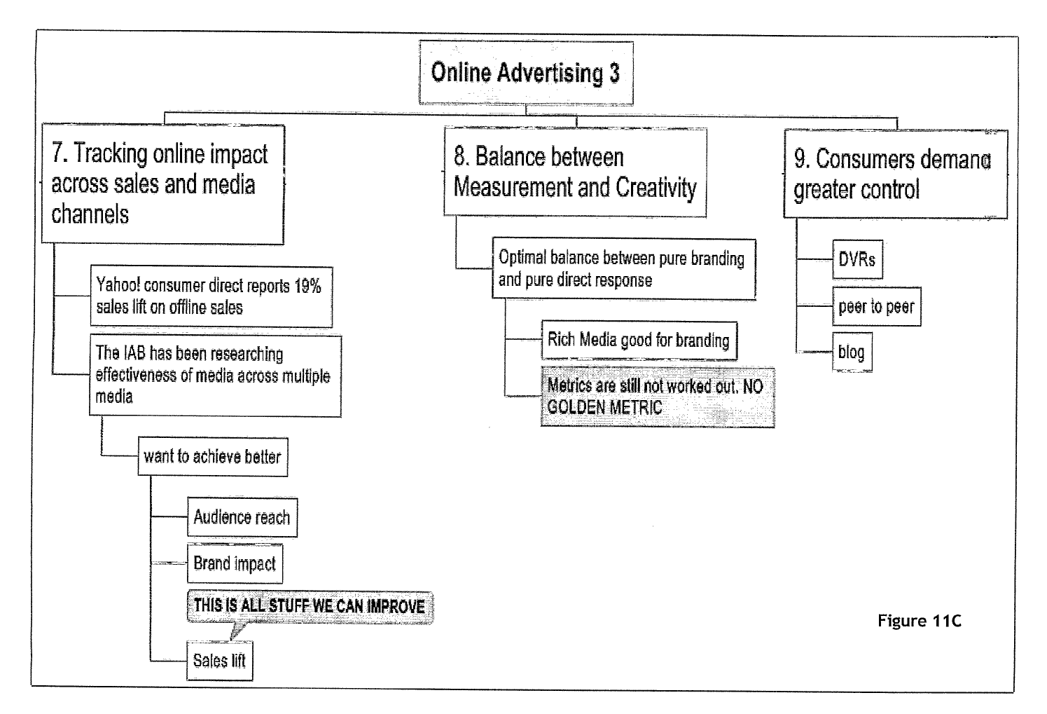

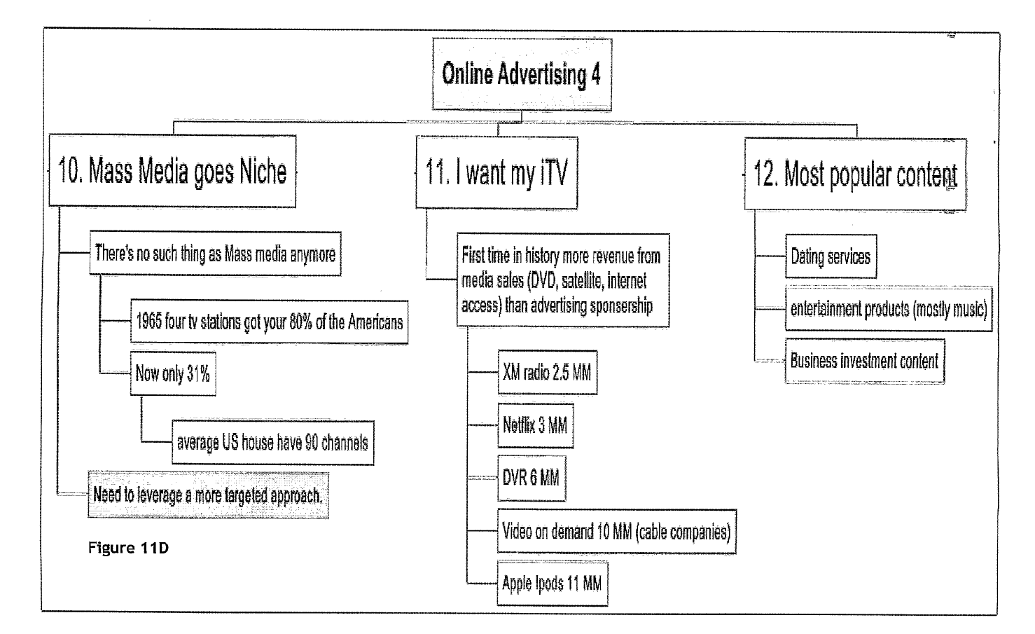

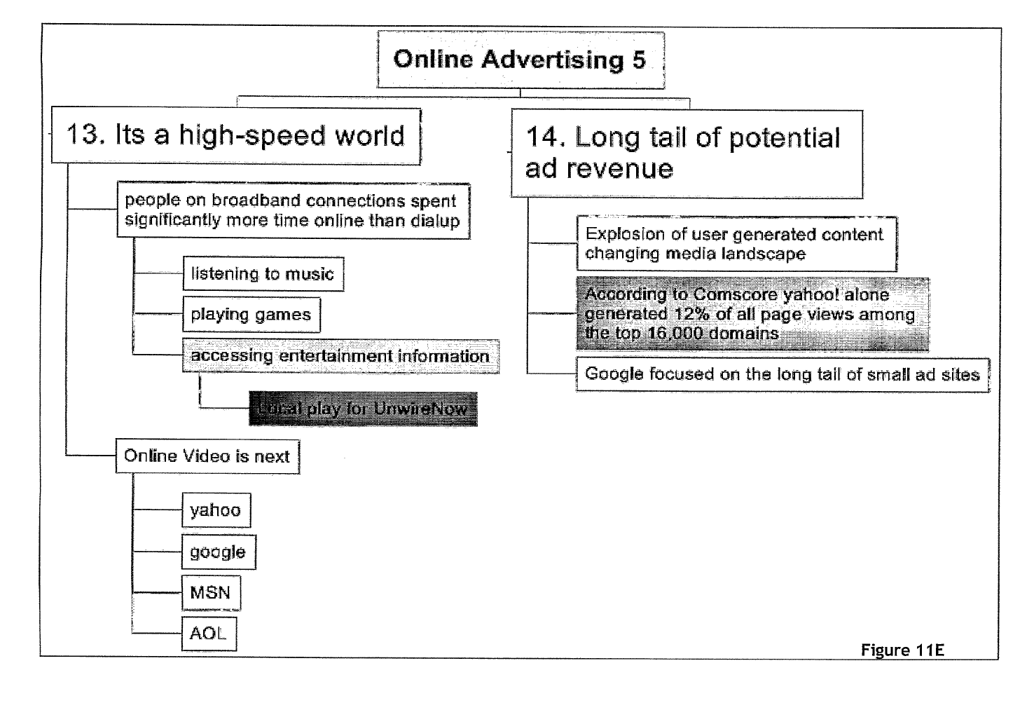

FIG. 11 is a chart illustrating various business method/model considerations relating to online advertising implementations, according to some embodiments of the present invention. The chart details the slow adoption of multi-media content by advertisers relative to consumers, identifies issues related to targeting consumers, and advertiser-related considerations that web-sites should take into account when devising advertising-based revenue models for a web-site or group of sites. The chart notes that content-rich media has a greater probability of attracting end-user attention. However, content-rich multi-media content demands bandwidth that is not practicable in the current carpet-bombing advertising methodologies practiced by web sites.

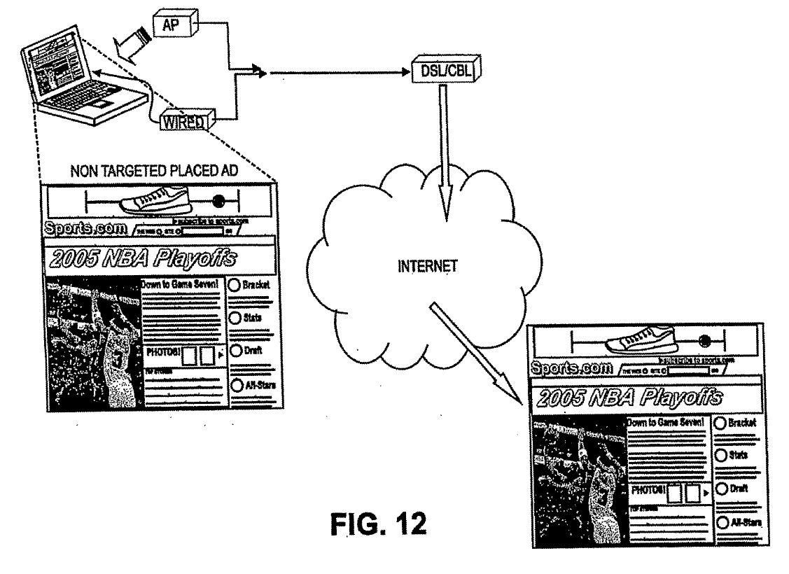

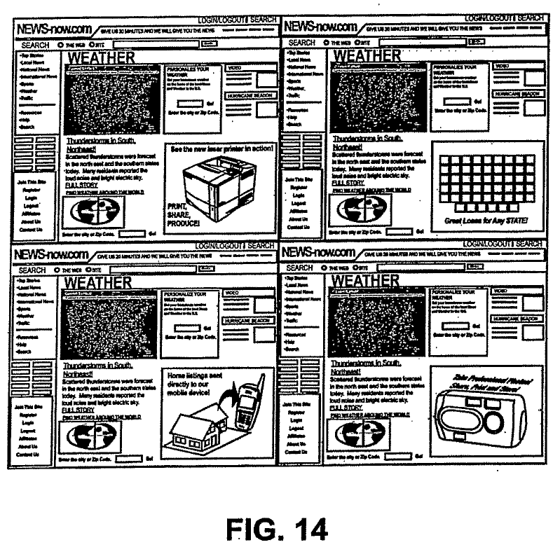

FIG. 12 illustrates traditional web-based advertising methodology. As shown in FIG. 12, a web-site chooses from a limited inventory of advertisements, as shown in FIG. 14, and picks an advertisement for display on a user's browser based on rough demographic or cookie-based information that may be provided to the ad-server.

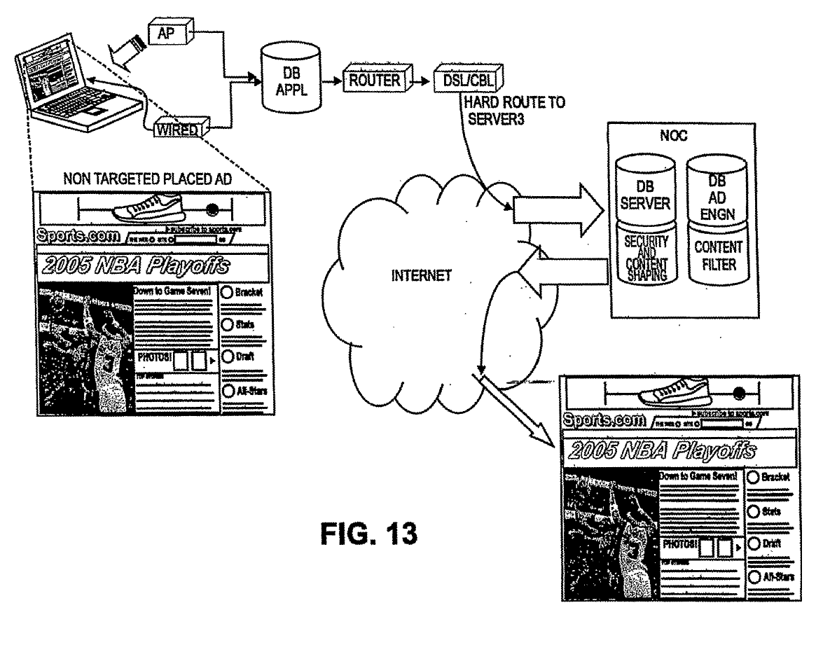

FIG. 13 illustrates a targeted advertising methodology according to embodiments of the present invention. As shown in FIG. 13, the ad-server now has information provided by the DTD Network Operations Center (DTD NOC). At the DTD NOC, a DTD Server may read a database to get profile information, as well as analyze information regarding location-centric information provided by an AP server. This information may be packaged and provided to the ad-server, which uses the packaged information to pick an advertisement targeted at the end-user based on the analyzed profile and location information. The targeted advertisement is then served to the end-user as shown in FIG. 12 under the heading “LOCAL TARGETED AD.”

FIG. 14 illustrates current advertising inventory at a site using traditional web-based advertising methodologies. On account of the fact that every user must be served multiple advertisements, bandwidth, time spent by the user at the site and other considerations dictate that only a few advertisements form the ad-inventory of a web site. These advertisements are placed in rotation on a user-screen, in the hope of generating a response. In fact, on some sites because of the limited inventory that may be displayed to a user, advertising space has been sold-out years into the future. Thus, the site operator is precluded from generating additional revenue barring change in the way advertising is currently practiced.

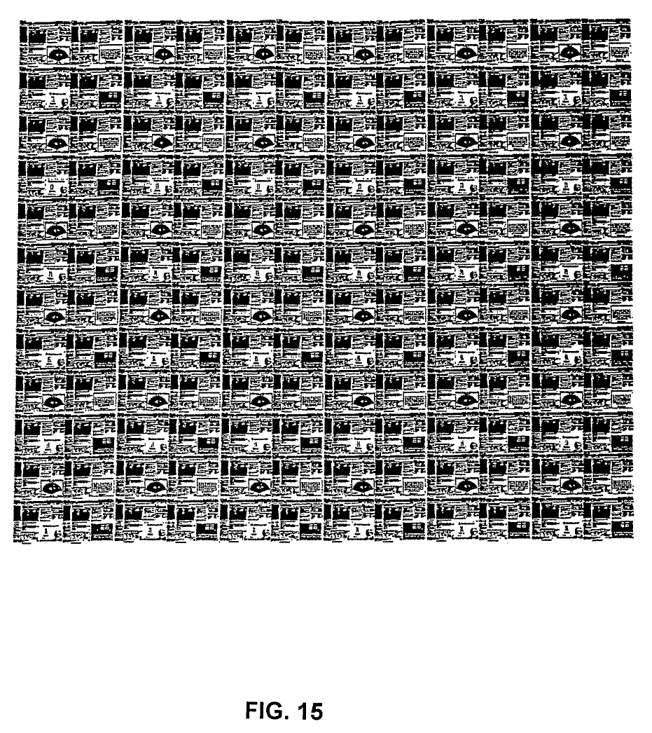

FIG. 15 illustrates how advertising inventory has increased at the site following adoption of methodology according to embodiments of the invention. On account of the targeted delivery of advertisements, a site operator is now able to display a larger inventory of advertisements. This is because, better targeting leads to better click-through rates or user-responses, leading to more revenue for the site-operator for the same number of advertisements displayed. In addition, advertisers also benefit because there is a higher probability that a person shown an advertisement is actually a potential customer. A substantial increase in the revenue stream available to a site-operator is possible by adoption of methodologies in accordance with embodiments of the present invention.

Embodiments of the invention relate to a business method using technology and methodology to combine the location-centric and user profile data in order to identify and suggest preferences, and deliver content to a user. Further, embodiments of the method also allow the content providers to accurately measure the frequency and locations to which a particular piece of information has been delivered. As a result, a content provider may accurately determine the effectiveness of a particular class of content, and be able to customize content such as language, format (e.g. colors, video, images, audio) etc. according to its desired demographic structures.

Embodiments of the invention also relate to business methods, which allow for the creation and/or identification of demographically alike but geographically dispersed communities and make targeted content delivery possible to these communities.

In some embodiments, the AP server may be comprised of: (1) a processor; (2) a configuration component/module; and (3) processing software; and (4) appropriate memory, storage, networking capabilities and associated peripherals. All of these elements can be unitary or distributed.

The access point configuration component/module can be a configuration module that includes setup configuration information uploaded prior to implementation, wherein the setup configuration information includes home page redirection information, XML-enabled interface information, and portal redirect with parameter passing information.

The access point processing software can include a redirection procedure/routine, wherein the processing software comprises a program of instructions instructing the processor to perform the steps of:

relaying a request from the user regarding access to the network including LOCAL DATA;

in response to the requester, receiving an authorization/T&C page from the server, and passing/providing this page to the user, wherein the one or more initial web pages includes information determined by the processing software as a function of the LOCAL DATA; and

opening up a connection for the user once the user has accepted the T&C; whereby connection of the user to the management server is implemented in association with the provision, by the access device, of LOCAL DATA (unique to the location and the user's MAC), and usage authorization and provision of unique content based on the LOCAL DATA is enabled.

Further system and method implementations are detailed below, according to some embodiments of the present invention. These implementations are useful, for example, within the systems and methods characterized by implementing a DTD server; deploying an access device into the network; requesting authorization to use the public-access network, including transmission of unique identification information for the user with the authorization request; transmitting data including a splash page having sponsor information (e.g., media), relevant information based on access device location, and/or terms and conditions for using the network, wherein the data to be transmitted is determined by the processing software as a function of the user's unique identification information; and transmitting instructions to open up a connection for that specific user.

Regarding, the wireless implementation addressed above, embodiments of the present invention provide advantages pertaining to direct access, location, traffic management, and network operations. With respect to direct access, the present invention provides direct connection to the customer and eliminates third party involvement in the delivery of content, as well as allowing the licensee, subscriber, or vendor to be the starting point of each and every communication (e.g., page, flash page, search, etc.) with the customer. With respect to location, the present invention provides the exact location of the customer, providing significantly greater value to advertising-related information and other content. In other words, focused encapsulated information about a customer is more valuable to advertisers desiring directed advertising and other communications. With respect to traffic considerations, the cost methodologies addressed herein provide for greater accessibility, as costs present a significant competitive barrier. Specifically, some embodiments of the present inventive methodology allow for the provision of free Internet access to end-users. Therefore, from a traffic maximization point of view, these embodiments are advantageous for networks such as those that are: (1) carrier class networks, (2) easy to log onto, and (3) ubiquitous. Finally, with respect to network operations, the present methodology provides relatively low equipment costs for access to customer information of this nature, as well as the capability of avoiding the expenses associated with implementing and/or managing a network of this size and quality.

The technology set forth herein, describing embodiments of the invention, has applicability to the operation of Wi-Fi networks, and to organizations closely associated with the deployment and provision of Wi-Fi technology. Systems and methods according to embodiments of the present invention provide numerous advantages in the areas of network management and operation, data collection and aggregation, real-time provision of user demographics, location and other information, and reporting of Wi-Fi network usage (for example, summaries, or aggregate statistics, even in real-time). The Wi-Fi embodiments described may have specific applicability to service providers, portals, and Internet ad intermediaries.

For example, systems and methods according to embodiments of the present invention provide unique advantages to service providers like Voice over IP (“VoIP”) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). Embodiments of the present invention also provide significant advantages to portals, such as real-time user demographics and location information that allow for immediate, directed advertising. Embodiments of the present invention also provide significant advantages to internet advertising intermediaries, such as information management applicable to all of the many layers of service providers involved in having an advertisement (such as a banner) displayed on a web page.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention.

1. A method comprising:
registering users logging-on to a computer network;
gathering user-related information from users;
relaying location-centric information to a server for each user logged-on to the network;
retrieving user-profile information for each user from a database based on user-related information;
processing the user-profile and location-centric information for each user to get targeting information for each user; and
sending the targeting information to a content-provider wherein the content-provider uses the targeting information to select content to be displayed to users.

2. The method claim 1, wherein the computer network is a wireless network to which users log-on to gain access to the Internet.

3. The method of claim 2, wherein the computer network is publicly accessible.

4. The method of claim 1, wherein the computer network is a broadband network onto which the users login to access Internet and/or Internet content.

5. The method of claim 4, wherein the broadband network is a DSL, Cable, IPTV or Fixed Broadband Wireless network.

6. The method of claim 1, wherein the computer network is a broadband wireless mobile network onto which the users login to access Internet and/or Internet content.

7. The method of claim 6, wherein the broadband wireless mobile network is a cellular, a WiMAX, a 3G, or a 4G network.

8. The method of claim 1, including displaying selected targetable content, which is modified based on user a preference and/or a user profile, on a browser associated with the user.

9. The method of claim 8, wherein the targetable content includes results of a search query.

10. A method comprising:
storing an inventory of targetable content;
receiving targeting information pertaining to users of a web site;
selecting targetable content for each user of the web-site based on the targeting information received for that user; and
displaying the selected targetable content on the user's browser.

11. The method of claim 10, wherein displaying the selected targetable content on the user's browser further comprises modifying the content based on user-preferences.

12. The method of claim 10, wherein displaying the selected targetable content on the user's browser further comprises modifying the content based on parameters of the display being used by the web-site user.

13. The method of claim 10, wherein the selected targetable content is modified based on user a preference and/or a user profile.

14. The method of claim 13, wherein the targetable content includes results of a search query.

15. The method of claim 10, wherein the browser displaying the selected targetable content is modified based on a user preferences and/or a user profile.

16. The method of claim 15, wherein the selected targetable content includes results of a search query.

17. The method of claim 10, wherein the selected targetable content displayed is web data or a result of a video or audio stream, and the browser is modified based on a user preference and/or a user profile

18. The method of claim 10, wherein displaying the selected targetable content includes results of a security check based on one or more of a user preference, verification information identifying a device used to log into the network.
